(19) United States
(12) Patent Application Publication
(10) Pub. No.: US 2003/0043347 A1
(43) Pub. Date: Mar. 6, 2003

(54) System and method for providing overhead projection

(76) Inventor: Genaro Antonio Fernandez Orozco, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/943,050

(22) Filed: Aug. 30, 2001

(51) Int. Cl. G03B 21/00

(52) U.S. Cl. 353/31

(57) ABSTRACT

The present invention is directed to a system and method for providing an overhead image. A scan region receives a document containing an image to be projected. An illumination element illuminates the document to produce image light. A means for capturing and digitizing captures and digitizes the image light as digital information. A video subsystem produces a projection image from the digital information.

### TECHNICAL FIELD

The present invention is related to a system and method for providing overhead projection and in particular to a system and method for digitally processing a scanned image to provide an overhead projection.

### BACKGROUND

Overhead projectors provide a relatively simple mechanism to display information to a relatively large group of spectators to facilitate a discussion regarding a topic. Overhead projectors generally use a relatively high intensity bulb to illuminate a slide or piece of paper. The illuminated image from the slide or paper is enlarged via an optical lens system onto a screen for presentation to the group of spectators. Due to their simplicity, overhead projectors have become nearly ubiquitous at corporate meetings, seminars, university classes, and/or the like.

However, overhead projectors are quite limited. Specifically, the images produced by the overhead projectors may be of relatively poor quality. The text may be blurred and edges may be softened from enlargement of the image. Also, overhead projectors are quite bulky due to focal length constraints imposed by the optical lens system. Moreover, overhead projectors do not provide the capacity for spectators to retain any tangible form of the information contained in the slides or papers.

### SUMMARY OF THE INVENTION

The present invention is directed to a system and method for providing an overhead image. A scan region receives a document containing an image to be projected. An illumination element illuminates the document to produce image light. A means for capturing and digitizing captures and digitizes the image light as digital information. A video subsystem produces a projection image from the digital information.

### BRIEF DESCRIPTION OF THE DRAWING

FIG. 1 depicts an exemplary block diagram of an overhead projector arranged according to an embodiment of the present invention.

FIG. 2 depicts an exemplary view of an overhead projector arranged according to an embodiment of the present invention.

### DETAILED DESCRIPTION

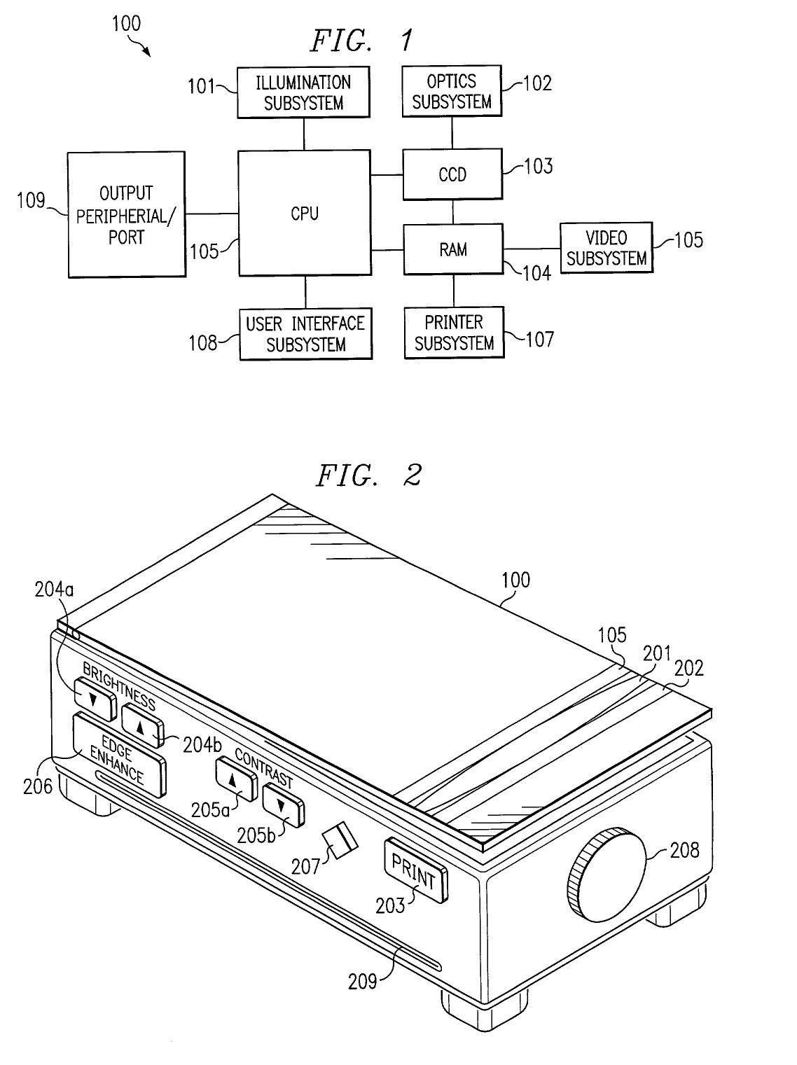

FIG. 1 depicts an exemplary block diagram of overhead projector 100 arranged according to an embodiment of the present invention. Overhead projector 100 includes illumination subsystem 101 to illuminate to a scan region. A document may be placed in the scan region so that its image will be projected by overhead projector 100. Any type of document may be utilized such as a paper, photograph, slide, and/or the like. Accordingly, the term “document” is intended to be used broadly as any type of suitable physical medium that can be used to form an image for projection. Overhead projector 101 further includes optic subsystem 100 to focus image light from the scan region onto charge coupled device (CCD) 101. In lieu of CCD 101, other optical detectors can be utilized such as a cathode ray tube. Optic subsystem 100 may comprise a lens to focus and reduce image light onto CCD 101. Optic subsystem 100 may include mirrors or reflective components to redirect image light to thereby create a more compact device housing if desired.

CCD 101 is a device that is well known in the art. Specifically, CCD 101 is a semiconductor device that provide an array of photo-sensitive elements to capture image light. Specifically, image light causes electronic capacitors to be charged by the incident light. The electronic capacitors are sampled to provide to an analog to digital convertor to create a digital representation of the captured incident light. CCD 101 may be implemented such that the entire image is captured via one operation, i.e., the area of CCD 101 is sufficiently large to capture all of the incident image light after optical reduction by a lens. Alternatively, CCD 101 may be implement as a single row of elements. In this case, CCD 101 may be associated with a carriage which is swept across the scan region to capture the entire image.

CCD 101 is communicatively coupled to random access memory (RAM) 104 to transfer the digital presentation of the captured image light into memory for processing by central processing unit (CPU) 105. Additionally, video subsystem 106 is communicatively coupled to RAM 104. Video subsystem 106 utilizes the digital information to generate a projection image. Specifically, video subsystem 106 drives, for example, a cathode ray tube (CRT) or liquid crystal display (LCD) to generate image light. The generated image light is then projected onto a screen for display to spectators.

Additionally, printer subsystem 107 is coupled to RAM 104. Printer subsystem may obtain image information in a suitable format to print a physical copy of the captured image. Specifically, CPU 105 may, in response to user input via user interface 108, create an appropriate print file in RAM 104 which corresponds to the captured image. For example, CPU 105 may create a POSTSCRIPT™ file in RAM 104. CPU 105 may cause printer subsystem 107 to receive the file from RAM 104. Printer subsystem 107 may utilize the file to create a hard copy or copies for spectators. Printer subsystem 107 may provide black and white printouts or color printouts. For example, printer subsystem 107 may include Hewlett-Packard inkjet printer HP deskjet 630c. Such an inkjet printer provides a compact footprint for inclusion in overhead projector 100 while producing appreciable print quality.

Moreover, CPU 105 may be communicatively coupled to output port 109. Output port 109 may provide a connection (such as a SCSI or RS-132 interface) to communicate with another processor-based system. Output port 109 can utilize any number of physical mediums and communication protocols. For example, output port 109 can utilize various cable based communication interfaces. Alternatively, output port 109 can utilize various wireless interfaces (e.g., infrared or RF interfaces). Alternatively, output port 109 may be coupled to a peripheral such as a floppy drive. CPU 105 may utilize output port 109 to provide an electronic copy of the captured image to a processor-based system of a spectator. For example, CPU 105 may convert the digital representation into a PDF™ file. A spectator may utilize a personal data assistant (PDA) to receive the file for future retrieval.

In preferred embodiments of the present invention, CPU 105 provides digital enhancement of the digital representation of the captured image. Specifically, an individual operating overhead projector 100 may supply a paper with a color background. When the specific color is projected onto a screen for viewing, the color background may reduce the readability of information on the paper. For example, relatively small text in footnotes may be obscured. CPU 105 may be operable to receive user input from user interface subsystem 108 to correct this condition. For example, CPU 105 may examine the background color. CPU 105 may replace the background color with a different color (e.g., white) to enhance the readability of the projected image. Alternatively, CPU 105 may be operable to remove or modify any color or color range that otherwise reduces readability of the projected image.

In another embodiment, CPU 105 may provide contrast enhancement. Specifically, CPU 105 may examine the range of variation between light and dark values in the digital representation stored in RAM 104. CPU 105 may process the digital information to cause light values to become lighter and to cause dark values to be darker. By doing so, the contrast of the image may be improved to enhance readability.

In yet another embodiment, CPU 105 may provide edge enhancement. To do so, CPU 105 first detects edges in the digital representation. Specifically, CPU 105 detects adjacent pixels along either side of a path or contour that possess significant variations in color or brightness. Edge enhancement may occur through several techniques. For example, the variation in color or brightness may be accentuated. Alternatively, the width of the path or contour may be widened so as to increase the sharpness of the edge.

FIG. 2 depicts an exemplary view of overhead projector 100 arranged according to an embodiment of the present invention. In this embodiment, overhead projector 100 includes CCD 105. CCD 105 is shown to be physically associated with illumination bulb 201 and mirror 202. Illumination bulb 201 illuminates a portion of the scan region while mirror 202 causes light reflected from the illuminated portion to be directed to CCD 105. In this case, CCD 105, bulb 201, and mirror 202 are operable to cause image capture and digitization of a relatively small portion of a document via one operation. Accordingly, CCD 105, bulb 201, and mirror 202 are preferably implemented on a carriage to sweep the elements across a document to capture and digitize the entire image.

Overhead projector 100 includes several input elements. Input elements 204a and 204b allow the user to adjust the brightness of the projected overhead image. Input elements 205a and 205b allow the user to adjust the processing of the captured digitized image to produce a desired level of contrast. Input element 206 allows the user to cause edge enhancement processing to occur. Overhead projector 100 further includes wireless interface 207 which may allow a user to download a digitized image via a PDA and/or the like. Overhead projector 100 further includes aperture 208 to facilitate output of the overhead image.

What is claimed is:

1. A system for providing an overhead image, comprising:
a scan region that receives a document containing data to be projected;
an illumination element that illuminates said document to produce image light;
means for capturing and digitizing said image light as digital information; and
a video subsystem that produces a projection image from said digital information.

2. The system of claim 1 further comprising:
a central processing unit (CPU) to process said digital information before receipt by said video subsystem.

3. The system of claim 2 wherein said CPU is operable to modify a color range of said digital information.

4. The system of claim 2 wherein said CPU is operable to increase contrast associated with said digital information.

5. The system of claim 2 wherein said CPU is operable to perform edge enhancement of said digital information.

6. The system of claim 2 wherein said CPU is operable to create a printable file utilizing said digital information.

7. The system of claim 2 wherein said CPU is operable to provide an electronic file of said digital information to an interface.

8. A method for providing an overhead image, comprising:
illuminating a document placed in a scan region to produce image light;
capturing said image light;
digitizing said image light to produce a digital image representation of said document;
processing said digital image representation to enhance readability of said digital image representation for overhead projection; and
driving a video subsystem with said processed digital image representation to project said overhead image.

9. The method of claim 8 wherein said step of processing is operable to remove a color range of said digital representation.

10. The method of claim 8 wherein said step of processing is operable to increase contrast associated with said digital image representation.

11. The method of claim 8 wherein said step of processing is operable to perform edge enhancement of said digital information.

12. The method of claim 8 further comprising:
creating a printable file format from said digital image representation.

13. The method of claim 8 further comprising:
creating an electronic file from said digital image representation; and
communicating said electronic file to a user device via an interface.

14. A system for providing an overhead image projection, comprising:
an illumination subsystem to illuminate a document to produce image light;
means for capturing and digitizing said image light to produce digital information;
memory for storing said digital information;
means for digitally enhancing said digital information to enhance readability of an overhead image; and
a video subsystem operable to project said overhead image utilizing said processed digital information.

15. The system of claim 14 wherein said means for capturing includes a charged coupled device (CCD).

16. The system of claim 14 wherein said means for digitally enhancing performs color removal.

17. The system of claim 14 wherein said means for digitally enhancing performs contrast enhancement.

18. The system of claim 14 wherein said means for digitally enhancing performs edge enhancement.

19. The system of claim 14 further comprising:
means for producing a printable file from said digital information.

20. The system of claim 14 further comprising:
means for producing a storable image file; and
an interface for communicating said storable image file to a user device.
